(19) United States
(12) Patent Application Publication
(10) Pub. No.: US 2008/0144855 A1
(43) Pub. Date: Jun. 19, 2008

(54) Vehicle communication and safety system

(76) Inventors: Arian M. Wimer, Tucson, AZ (US); Janice M. Wimer, Kelso, WA (US)

Correspondence Address: Arian M. Wimer, Unit #13206, 7050 E. Sunrise Drive, Tucson, AZ, 85750, US

(21) Appl. No.: 11/986,927

(22) Filed: Nov. 27, 2007

Related U.S. Application Data
(60) Provisional application No. 60/861,569, filed on Nov. 28, 2006.

(51) Int. Cl. H04B 1/00

(52) U.S. Cl. 381/86

(57) ABSTRACT

A communication and safety system disposed within a vehicle comprising a driver's seat, a steering wheel, and a second row of seats disposed behind the driver's seat, comprising a first microphone disposed adjacent the steering wheel; a first speaker disposed adjacent the steering wheel; a second microphone disposed adjacent the second row of seats; a second speaker disposed adjacent the second row of seats; a control system interconnecting the first microphone with the second speaker and interconnecting the second microphone with the first speaker.

### CROSS REFERENCE

This application claims priority from a United States Provisional Application having Serial No. U.S. 60/861,569 filed Nov. 28, 2006, wherein that Provisional Application is hereby incorporated herein by reference.

### BACKGROUND OF THE INVENTION

1. Field of the Invention

This invention is related in general to the field of vehicle communication and safety. In particular, this invention includes a control system that interconnects a first microphone and a first speaker located in the driver row of a vehicle with at least one speaker and at least one microphone located in a second row of a vehicle to allow communications between the driver row and the second row of the vehicle.

2. Description of the Prior Art

A person driving often wishes to communicate with other passengers in a vehicle. He/she also wishes to communicate with passengers in the vehicle safely without turning his/her head to the side or to the rear. For convenience and safety, those who desire to communicate safely with other passengers in the vehicle may wish to combine these features in a single device. However, a person who wants to communicate with other passengers in the vehicle must turn his/her head to the side or to the rear to be heard by other passengers. One problem with a person turning his/her head is a lack of attention to driving. Another problem is the driver is often unheard due to noise from the vehicle and other sources.

Accordingly, it is desirable to have a system that allows a user to simultaneously communicate with other passengers in the vehicle while still keeping his/her eyes on the road for safety.

### SUMMARY OF THE INVENTION

Applicants' invention disclosed herein comprises a communication and safety system disposed within a vehicle comprising a driver's seat, a steering wheel, and a second row of seats disposed behind the driver's seat, comprising a first microphone disposed adjacent said steering wheel; a first speaker disposed adjacent said steering wheel; a second microphone disposed adjacent said second row of seats; a second speaker disposed adjacent said second row of seats; a control system interconnecting said first microphone with said second speaker and interconnecting said second microphone with said first speaker.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments, and particularly pointed out in the claims. However, such drawings and description disclose just a few of the various ways in which the invention may be practiced and are not limiting.

### BRIEF DESCRIPTION OF THE DRAWINGS

FIG. 1 is an illustration of a communication system according to the invention including a first intercom assembly, a second intercom assembly, and a control system.

FIG. 2 is an illustration of the communication system according to the invention including a first intercom assembly, a second intercom assembly, a third intercom assembly, a fourth intercom assembly, a fifth intercom assembly, a sixth intercom assembly, a seventh intercom assembly, and an eighth intercom assembly.

FIG. 3 is an illustration of the communication system according to the invention.

FIG. 4 is an illustration of the communication system of FIG. 3 in an optional location on the upper frame of a vehicle.

FIG. 5 is an illustration of a flowchart describing steps for using the communication system of FIGS. 1, 2, 3, and 4.

FIG. 6 is an illustration of a flowchart describing steps for a user of the communication system of FIG. 3 of the vehicle to apply when utilizing different outputs.

### DESCRIPTION OF THE PREFERRED EMBODIMENTS

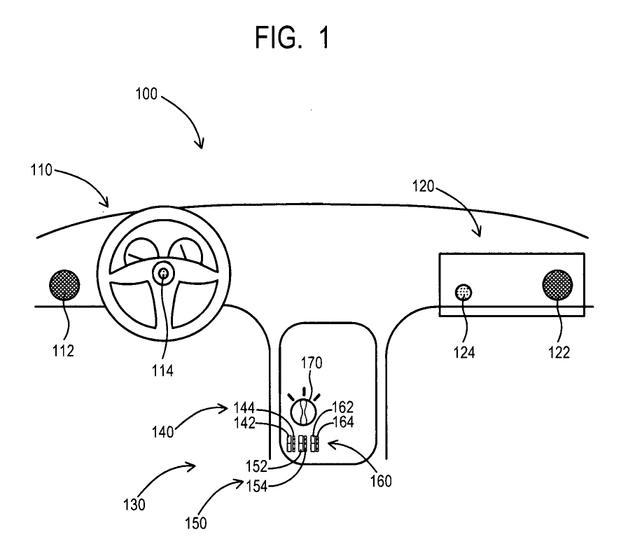

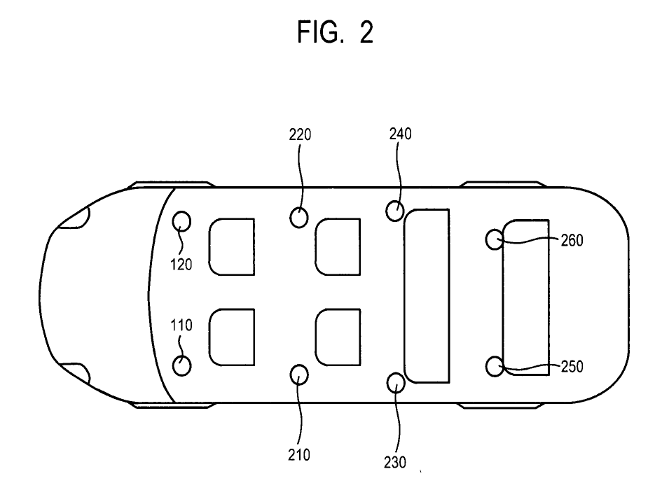

This invention is described in preferred embodiments in the following description with reference to the Figures, in which like numbers represent the same or similar elements. Referring now to FIG. 1, applicant's system 100 comprises intercom assembly 110, intercom assembly 120, and control system 130. In the illustrated embodiment of FIG. 1, intercom assembly 110 comprises speaker 112 and microphone 114. Speaker 112 provides audio output received from other intercom assemblies disposed throughout the vehicle thereby allowing the driver to hear communications from passengers in the front passenger seat and rear seats. This enables the driver to focus on the road ahead while still hearing communications from the rear seats and front passenger seat of the vehicle without turning his/her head. Microphone 114 optimally recognizes and transmits the human voice, thereby providing a voice output through speakers located throughout the front seat and rear seats of the vehicle (see FIGS. 2, 3, and 4).

In the illustrated embodiment of FIG. 1, speaker 112 is located on the dash board element of the vehicle to allow the driver to hear communications from the front seat passenger and rear seat passengers. In other embodiments, speaker 112 is located on the steering wheel, on the center console, on the driver-side door panel, on the upper frame of the vehicle, and the like. In the illustrated embodiment of FIG. 1, microphone 114 is located on the steering wheel. In other embodiments, microphone 114 is located on the dash board portion of a vehicle, on the center console, on the driver-side door panel, on the upper frame of the vehicle, and the like.

In the illustrated embodiment of FIG. 1, intercom assembly 120 comprises speaker 122 and microphone 124. Speaker 122 provides audio output for the front seat passenger to hear communication from persons in the rear seats of a vehicle and the driver. This enables the passenger to hear clearly communications from the rear seats and driver seat of the vehicle without straining and/or turning his/her head. Microphone 124 optimally recognizes and transmits the human voice thereby providing a voice output through speakers located throughout the front seat and rear seats of the vehicle (see FIGS. 2, 3, and 4).

In the illustrated embodiment of FIG. 1, speaker 122 is located on the dash board portion of the vehicle to provide audio output for the front passenger of a vehicle. In other embodiments, speaker 122 is located on the center console of a vehicle, on the passenger-side door panel, on the upper frame of the vehicle, and the like. In the illustrated embodiment of FIG. 1, microphone 124 is located on the right side of the dash board element of the vehicle. In other embodiments, microphone 124 is located on the center console of a vehicle, on the passenger-side door panel, on the upper frame of the vehicle, and the like.

In certain embodiments, speaker 112 and/or speaker 122 are commercially-available speakers that optimize audio output at human voice frequencies. In certain embodiments, microphone 114 and/or microphone 124 are commercially-available devices that recognize and receive human voice frequencies while rejecting audio input at other frequencies. In certain embodiments, speaker 112, speaker 122, microphone 114, and microphone 124 transition into mute mode upon incoming or outgoing cellular telephone communications made or received by the driver of the vehicle or front seat passenger. In certain embodiments, upon receiving an incoming cellular telephone communication, control system 130 interconnects microphone 114 with said incoming cellular telephone communication, while speaker 112, speaker 122, and microphone 124 transition into mute mode.

Control system 130 comprises a first set of controls 140, a second set of controls 150, and a third set of controls 160. First set of controls 140 comprises an on/off mechanism 142 and a volume control 144. First set of controls 140 are associated with the second row of seats in the vehicle. In the illustrated embodiment of FIG. 1, the on/off mechanism 142 comprises a switch that is urged in a first direction to turn the system on and urged in a second and opposite direction to turn the system off.

In the illustrated embodiment of FIG. 1, volume control 144 comprises a scroll lever that is moved in a first direction to increase the volume, and is moved in a second and opposite direction to decrease the volume. In certain embodiments, the on/off mechanism 142 and volume control 144 comprise an integral mechanism, such as for example and without limitation a push on/off button that rotates clockwise and counterclockwise to adjust volume levels.

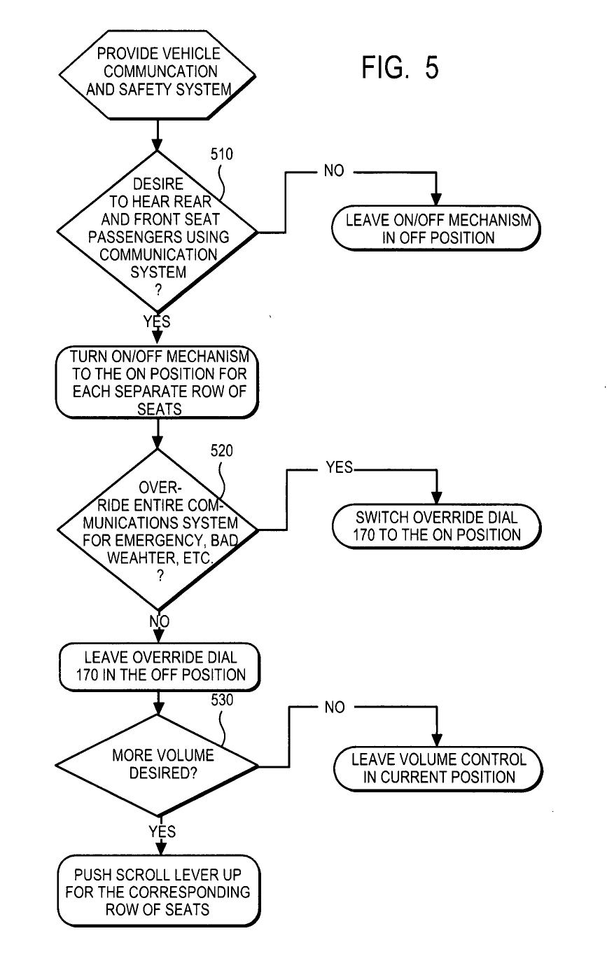

In other embodiments, the on/off mechanism 142 and volume control 144 comprise an integral mechanism that turns the system on when the dial is rotated clockwise and increases the volume as the dial is further rotated clockwise. When the dial is rotated completely counterclockwise, the system will turn off. The driver and front seat passenger can independently adjust intercom assemblies 110 and 120, respectively, without impacting the communication systems for rear seat passengers. (See FIG. 5 for flowchart describing steps for using communication system 100 which applies to all sets of controls and their different embodiments).

Second set of controls 150 comprises an on/off mechanism 152 and a volume control 154. Second set of controls 150 are associated with the third row of seats in the vehicle. In the illustrated embodiment of FIG. 1, the on/off mechanism 152 comprises a switch that is urged in a first direction to turn the system on and urged in a second and opposite direction to turn system off.

In the illustrated embodiment of FIG. 1, volume control 154 comprises a scroll lever that is moved in a first direction to increase the volume, and is moved in a second and opposite direction to decrease the volume. In certain embodiments, the on/off mechanism 152 and volume control 154 comprise an integral mechanism, such as for example and without limitation a push on/off button that rotates clockwise and counterclockwise to adjust volume levels.

In other embodiments, the on/off mechanism 152 and volume control 154 comprise an integral mechanism that turns the system on when the dial is rotated clockwise and increases the volume as the dial is further rotated clockwise. When the dial is rotated completely counterclockwise, the system will turn off. The driver and front seat passenger can independently adjust intercom assemblies 110 and 120, respectively, without impacting the communication systems for rear seat passengers.

Third set of controls 160 comprises an on/off mechanism 162 and a volume control 164. Third set of controls 160 are associated with the fourth row of seats in the vehicle. In the illustrated embodiment of FIG. 1, the on/off mechanism 162 comprises a switch that is urged in a first direction to turn the system on and urged in a second and opposite direction to turn system off.

In the illustrated embodiment of FIG. 1, volume control 164 comprises a scroll level that is moved in a first direction to increase the volume, and is moved in a second and opposite direction to decrease the volume. In certain embodiments, the on/off mechanism 162 and volume control 164 comprise an integral mechanism, such as for example and without limitation a push on/off button that rotates clockwise and counterclockwise to adjust volume levels.

In other embodiments, the on/off mechanism 162 and volume control 164 comprise an integral mechanism that turns the system on when the dial is rotated clockwise and increases the volume as the dial is further rotated clockwise. When the dial is rotated completely counterclockwise, the system will turn off. The driver and front seat passenger can independently adjust intercom assemblies 110 and 120, respectively, without impacting the communication systems for rear seat passengers.

As a general matter, when implementing Applicants' system in a vehicle comprising (N) rows of seating that apparatus will comprise (N) control system mechanisms.

In the illustrated embodiment of FIG. 1, override control 170 can be used by the driver or front seat passenger to disable the entire communication and safety system 100. This allows the driver or front seat passenger to turn the system 100 off during an emergency situation, when driving in bad weather, or like situations. In the illustrated embodiment of FIG. 1, override control 170 comprises a dial that is rotated in a first direction to turn the system on and rotated in a second and opposite direction to turn the system off. In certain embodiments, override control 170 comprises a switch that is urged in a first direction to turn the system on and urged in a second and opposite direction to turn the system off. In other embodiments, override control 170 comprises a push button that turns the system on when depressed and turns the system off when not depressed.

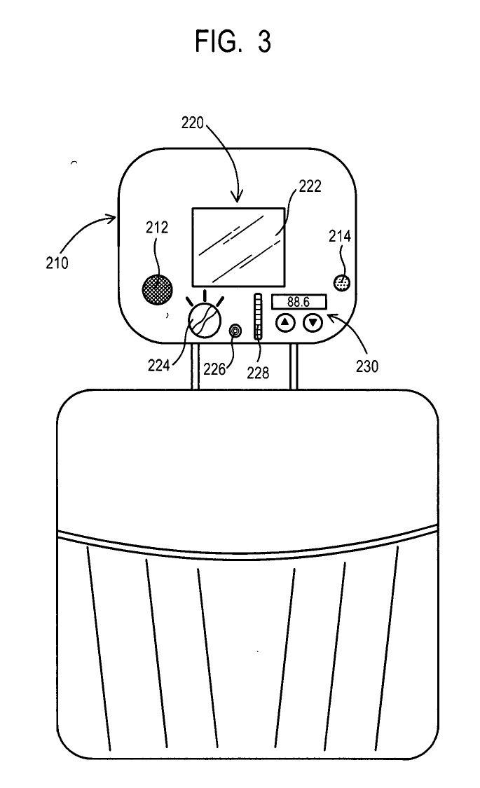

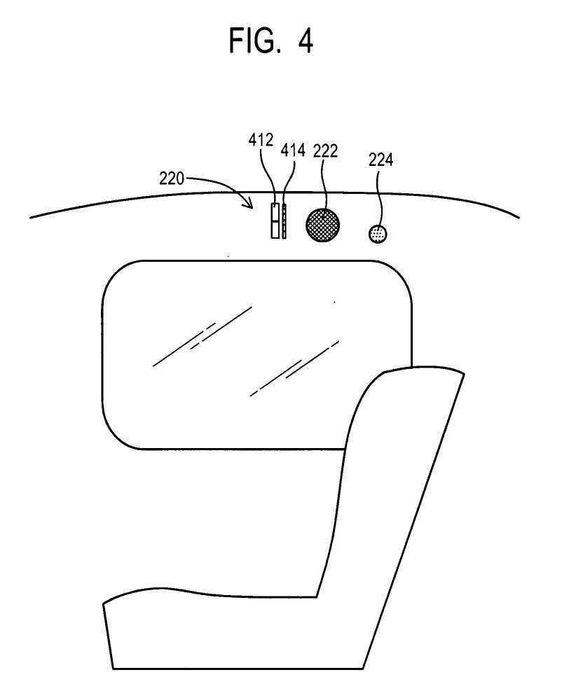

Referring to FIG. 2, a vehicle is shown from a top view with first intercom assembly 110, second intercom assembly 120, third intercom assembly 210, fourth intercom assembly 220, fifth intercom assembly 230, sixth intercom assembly 240, seventh intercom assembly 250, and eight intercom assembly 260. Each intercom assembly corresponds to a particular seat within a vehicle. In other embodiments, more intercom assemblies will correlate with more seats within a vehicle. In the illustrated embodiment of FIG. 2, each intercom assembly comprises a speaker (see FIGS. 3 and 4) and a microphone (see FIGS. 3 and 4).

Referring to FIG. 3, intercom system 210 comprises speaker 212 and microphone 214. In the illustrated embodiment of FIG. 3, speaker 212 is located on the back of the headrest of a vehicle to allow a rear seat passenger to hear communications from the other passengers. In other embodiments, speaker 212 is located on the door panel of a vehicle, on the upper frame of the vehicle (see FIG. 4), on the rear portion of a facing seat, and the like. In the illustrated embodiment of FIG. 3, microphone 214 is located on the back of the headrest. In other embodiments, microphone 214 is located on the door panel of a vehicle, on the upper frame of the vehicle (see FIG. 4), on the back of the seat, and the like. The location and function of the intercom assembly in the illustrated embodiment of FIG. 3 corresponds to all intercom assemblies of the rear passengers throughout the vehicle.

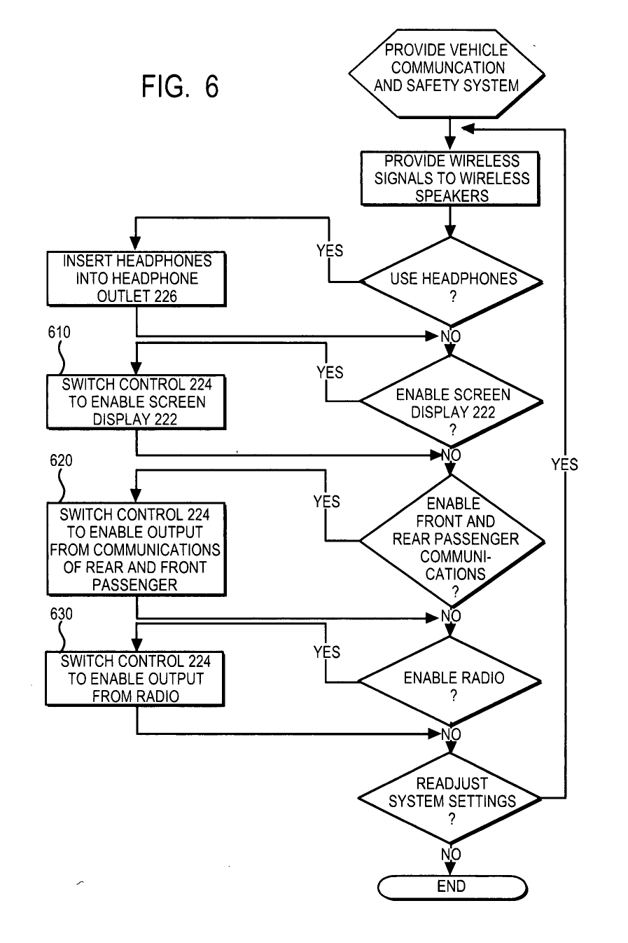

Illustrated in the embodiment of FIG. 3, system 220 comprises a screen 222, control 224, headphone outlets 226, volume control 228, and radio control 230. Screen 222 is used to display movies, play games, and the like. Control 224 can be rotated clockwise and counterclockwise to correspond to the wanted function of the output sound. Referring now to FIG. 6, one such scenario 610 is to turn control 224 to enable the sound to come through the speaker 212 or headphones inserted into the headphone outlet 226 that corresponds to the activity on the screen 222. In the illustrated embodiment of FIG. 6, another scenario 620 is to turn the control 224 to enable the sound to come through the speaker 212 or headphones inserted into the headphone outlet 226 that corresponds to the communications of the front and rear seat passengers. In the illustrated embodiment of FIG. 6, another scenario 630 is to turn the control 224 to enable the sound to come through the speaker 212 or headphones inserted into the headphone outlet 226 that corresponds to the chosen radio waves through radio control 230. In other embodiments, control 224 comprises a switch that can be pushed upward and downward to correspond to the wanted function of the output sound. In other embodiments, control 224 comprises a digital control with corresponding buttons to maneuver through the various options, screen activity 222 or front and rear passenger communications or radio 230, to enable rider to choose sound he/she will hear through headphone inserted into headphone outlet 226. (see flowchart in FIG. 6).

Referring to FIG. 4, intercom assembly 220 comprises speaker 222 and microphone 224. In the illustrated embodiment of FIG. 4, speaker 222 is located on the upper frame of a vehicle to allow a rear seat passenger to hear communications from the other passengers. In other embodiments, speaker 222 is located on the door panel of a vehicle, on the back of the seat, on the back of the headrest (see FIG. 3), and the like. In the illustrated embodiment of FIG. 4, microphone 224 is located on the upper frame of the vehicle. In other embodiments, microphone 224 is located on the door panel of a vehicle, on the back of the seat, on the back of the headrest (see FIG. 3), and the like. The location and function of the intercom assembly in the illustrated embodiment of FIG. 3 corresponds to all intercom systems of the rear seats throughout the vehicle.

As illustrated in FIG. 4, intercom system 220 comprises an on/off mechanism 412 and a volume control 414. In the illustrated embodiment of FIG. 4, the on/off mechanism 412 comprises a switch that is urged in a first direction to turn the system on and urged in a second and opposite direction to turn the system off.

In the illustrated embodiment of FIG. 4, volume control 414 comprises a scroll lever that is moved in a first direction to increase the volume, and is moved in a second and opposite direction to decrease the volume. In certain embodiments, the on/off mechanism 412 and volume control 414 comprise an integral mechanism, such as for example and without limitation a push on/off button that rotates clockwise and counterclockwise to adjust volume levels.

In other embodiments, the on/off mechanism 412 and volume control 414 comprise an integral mechanism that turns the system on when the dial is rotated clockwise and increases the volume as the dial is further rotated clockwise. When the dial is rotated completely counterclockwise, the system will turn off. The rear seat passenger can turn, separately, the communication system on or off and control the volume of their corresponding intercom system in the vehicle without hindering the communication system for seats located more to the forward or rear of the vehicle. Intercom system 220 comprising on/off mechanism 412 and volume control 414 as illustrated in FIG. 4 corresponds to all rear seats in a vehicle.

Referring now to FIG. 5, in step 510 the driver or front seat passenger of a vehicle determines if he/she wants to hear the rear and front seat passengers. If the driver or front seat passenger of a vehicle determines he/she desires to hear the rear and front seat passengers, the driver or front seat passenger turns the on/off mechanism that corresponds with each separate row to the on position. If the driver or front seat passenger of a vehicle determines he/she does not desire to hear the rear and front seat passengers, the driver or front seat passenger leaves the on/off mechanism for corresponding rows in the off position.

In the illustrated embodiment of FIG. 5, in step 520 the driver or front seat passenger determines if he/she wants to override the vehicle and communication system 100. If the driver or front seat passenger determine he/she does want to override the vehicle and communication system 100, the driver or front seat passenger turns the override control 170 to the on position. If the driver or front seat passenger determines he/she does not want to override the vehicle and communication system 100, the driver or front seat passenger will leave the override control 170 in the off position.

In the illustrated embodiment of FIG. 5, in step 530 the driver or front seat passenger determines if he/she wants more volume. If the driver or front seat passenger desires more volume, he/she pushes the scroll lever up for the corresponding row in the vehicle in which he/she desires more volume. If the driver or front seat passenger determines he/she does not want more volume, he/she will leave the volume control in a current position.

In certain embodiments, each intercom assembly described herein communicates with an associated control system via a communication link. In certain embodiments, one or more of such communication links comprises an interconnecting cable. In certain embodiments, one or more of such communication links comprise a wireless communication link. In certain embodiments, such a wireless communication link utilizes the Bluetooth® communication protocol.

Those skilled in the art of making communication systems may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A communication and safety system disposed within a vehicle comprising a driver's seat, a steering wheel, and a second row of seats disposed behind the driver's seat, comprising:
a first microphone disposed adjacent said steering wheel;
a first speaker disposed adjacent said steering wheel,
a second microphone disposed adjacent said second row of seats;
a second speaker disposed adjacent said second row of seats;
a control system interconnecting said first microphone with said second speaker and interconnecting said second microphone with said first speaker.

2. The communication and safety system of claim 1, further comprising an override assembly disposed adjacent said steering wheel, wherein activation of said override mutes said first speaker and said second speaker.

3. The communication and safety system of claim 1, further comprising a cellular telephone input connection to said control system, wherein upon receiving an incoming call on a cellular telephone interconnected to said cellular telephone input connection said control system:
interconnects said first microphone with said cellular telephone;
disables said second microphone; and
disables said second speaker.

4. The communication and safety system of claim 1, wherein said first microphone is disposed in said steering wheel.

5. The communication and safety system of claim 4, wherein said first speaker is disposed within said steering wheel.

6. The communication and safety system of claim 1, wherein said vehicle further comprises a dash board, and wherein said first microphone is disposed in said dash board.

7. The communication and safety system of claim 6 wherein said first speaker is disposed within said dash board.

8. The vehicle communication and safety system of claim 1, wherein said control system comprises a first control mechanism disposed adjacent said steering wheel, wherein said first control mechanism comprises:
a first on/off switch operative to enable or disable said second microphone;
a first volume adjustment to adjust the volume of audible signals emitted by said first speaker.

9. The vehicle communication and safety system of claim 8, wherein said first control mechanism is disposed within said steering wheel.

10. The communication and safety system of claim 8, wherein said vehicle further comprises a dash board, and wherein said first control mechanism is disposed in said dash board.

11. The vehicle communication and safety system of claim 8, wherein said control system comprises a second control mechanism disposed adjacent said second row of seats, wherein said second control mechanism comprises:
a second on/off switch operative to enable or disable said second microphone;
a second volume adjustment to adjust the volume of audible signals emitted by said second speaker.

12. The vehicle communication and safety system of claim 11, wherein said driver's seat comprises a head rest comprising a forward-facing surface and a rearward-facing surface, wherein said second control mechanism is disposed in said rearward-facing surface of said head rest.

13. The vehicle communication and safety system of claim 12, wherein said second speaker and said second microphone are disposed in said rearward-facing surface of said head rest.

14. The vehicle communication and safety system of claim 12, further comprising a headphone jack disposed in said rearward-facing surface of said head rest, wherein a set of headphones interconnected to said headphone jack are coupled to said control system and receive audio signals also provided to said second speaker.

15. The vehicle communication and safety system of claim 14, wherein a set of headphones interconnected to said headphone jack receive audio signals from said control system and said second speaker is muted.

16. The vehicle communication and safety system of claim 13, further comprising:
a visual display device disposed in said rearward-facing surface of said head rest;
a DVD player comprising a video out port and an audio out port, wherein said video out port is interconnected to said visual display device and said audio out port is interconnected to said second speaker.

17. The vehicle communication and safety system of claim 16, further comprising a headphone jack disposed in said rearward-facing surface of said head rest, wherein a set of headphones interconnected to said headphone jack are coupled to audio out port.

18. The vehicle communication and safety system of claim 13, further comprising:
a visual display device disposed in said rearward-facing surface of said head rest;
a video game console comprising a video out port and an audio out port, wherein said video out port is interconnected to said visual display device and said audio out port is interconnected to said second speaker.

19. The vehicle communication and safety system of claim 18, further comprising a headphone jack disposed in said rearward-facing surface of said head rest, wherein a set of headphones interconnected to said headphone jack are coupled to said audio out port.

20. The vehicle communication and safety system of claim 14, wherein a set of headphones interconnected to said headphone jack are coupled to said audio out port and said second speaker is muted.
